(19) United States
(12) Patent Application Publication
(10) Pub. No.: US 2005/0241198 A1
(43) Pub. Date: Nov. 3, 2005

(54) Advertising stand

(76) Inventor: Jori Santeri Valtonen, Tampere (FI)

Correspondence Address: STITES & HARBISON PLLC, 1199 NORTH FAIRFAX STREET, SUITE 900, ALEXANDRIA, VA, 22314, US

(21) Appl. No.: 10/517,598

(22) PCT Filed: Jun. 13, 2003
(86) PCT No.: PCT/FI03/00472

§ 371 Date: Dec. 13, 2004

(30) Foreign Application Priority Data
Jun. 13, 2002 (FI) US20020284

(51) Int. Cl. G09F 15/02

(52) U.S. Cl. 40/606.01

(57) ABSTRACT

An advertising stand (1) to be used in a winter sport resort, comprised of frame portion (4) and of a foot portion (5) placed under the snow cover and a frame portion (3) placed above the snow cover. The upper and lower portions (3, 4) are profiles and between them one or more advertising surfaces (2) can be fixed, and a frame profile (3) above the snow cover is arranged as performance place of the winter sport resort, as a rail, on which it is possible to move, for instance with a snow board.

This invention relates to an advertising stand for use in a winter sport resort, comprised of a frame portion and a foot portion placed under the snow cover, and a frame portion (3) placed above the snow cover and working as a place of performance for down hill skiers in the slalom slope.

It is well known that in winter sport resorts many kinds of advertising is carried out in the vicinity of uphill tracks, slalom slopes and service facilities. It is also known that in ski resorts in addition to ski jumps of snow and similar, as places of performance handrail-like structures of metal, plastic and wood or combinations of them are arranged, for more challenge. These handrail-like structures are used by downhill skiers, for instance gliding on them with downhill equipment.

These previously known structures are built to work as additional challenge for downhill skiers and not as an advertising stand. Neither has any special attention been paid to them. Correspondingly, previously known advertising stands have functioned as passive advertising stands without bringing any extra value as performance places of downhill skiers.

The advertising stand as per the invention is characterized in that the upper and lower frame are profiles and one or more advertising surfaces can be fixed between them and that the frame profile above the snow cover is arranged as performance place, as a rail, on which it is possible to move for instance with a snow board.

The advertising stand as per the invention has remarkable advantages. It can be placed freely in the slalom slope working there as a performance place offering extra challenge. The uniform metal frame of the advertising stand, smooth advertising surface and additional supports of wood reduce the risk of damage of skier and slalom equipment in the place of performance in cases of collision and tumble, with other words increase the safety of the place of performance and the slalom slope.

The advertising stand as per the invention is easily moved and placed in slalom slopes of different type, so advertising stands of same type can be used in many winter sport resorts, which is advantageous on producing several each of same advertising surfaces. Since advertising surfaces to be fixed in an advertising stand as per the invention can be made as light constructions and are easily fixed, the advertising surfaces are profitable to produce and exchange.

In the following the invention is disclosed with reference to he enclosed drawings, where

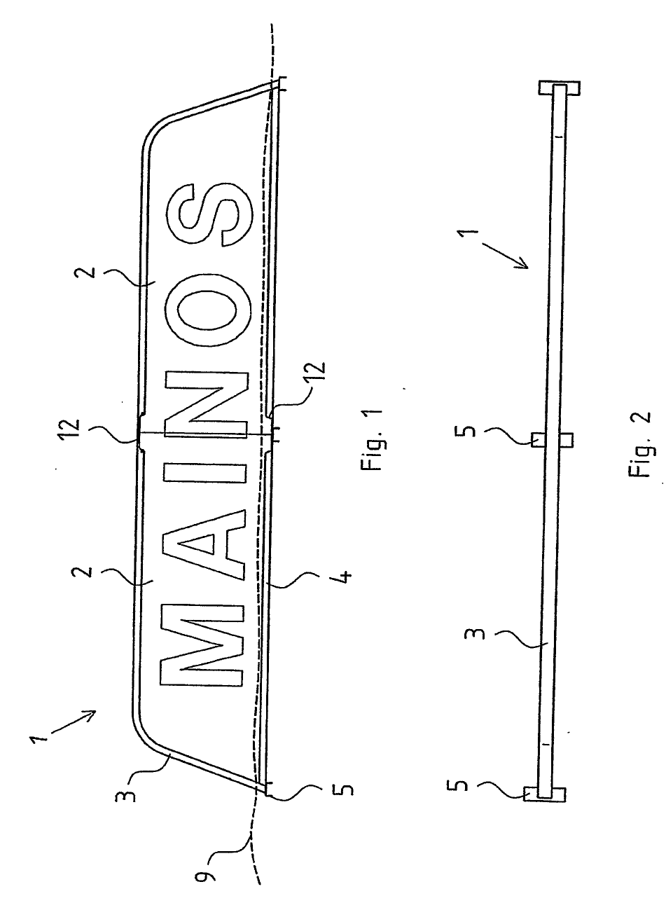

FIG. 1 shows one advertising stand as per the invention from the side,

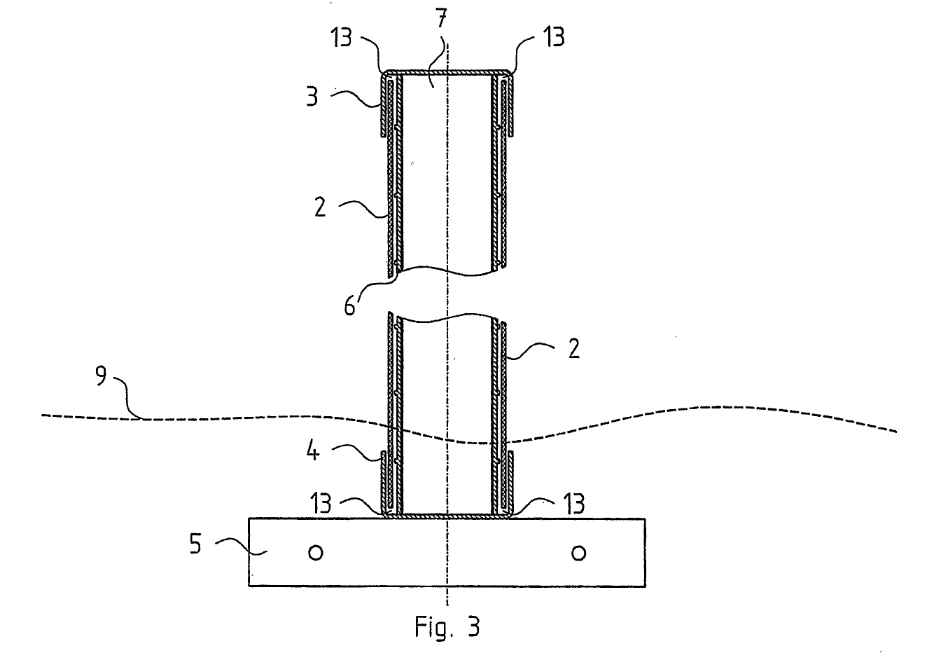

FIG. 2 shows ditto viewed from above,

FIG. 3 shows in a greater scale the cross section of the structure of the advertising stand as per the invention,

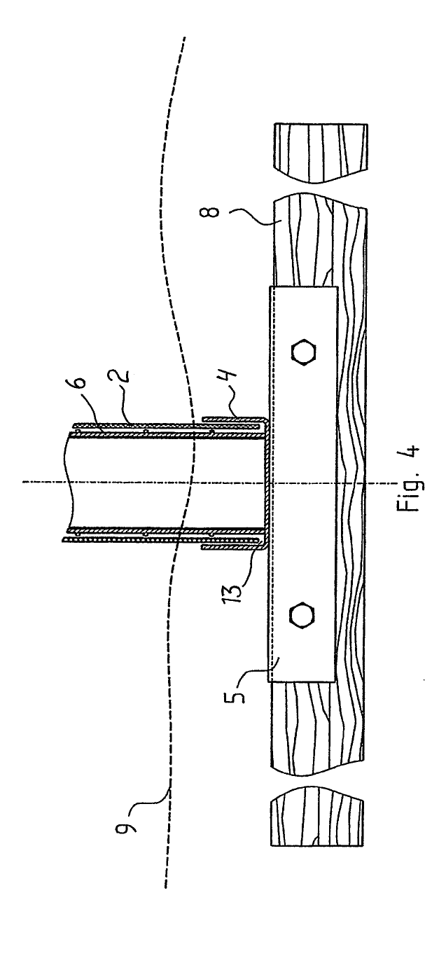

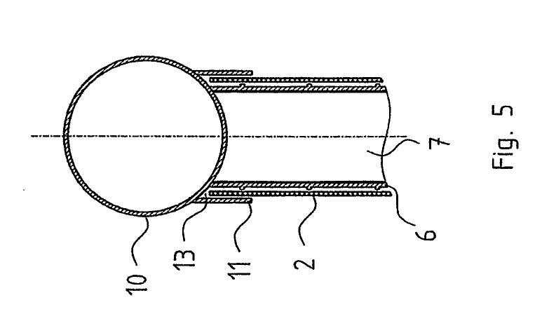

FIGS. 4 and 5 show alternative details of FIG. 3,

FIG. 6 shows one form of alternative the advertising stand from the side,

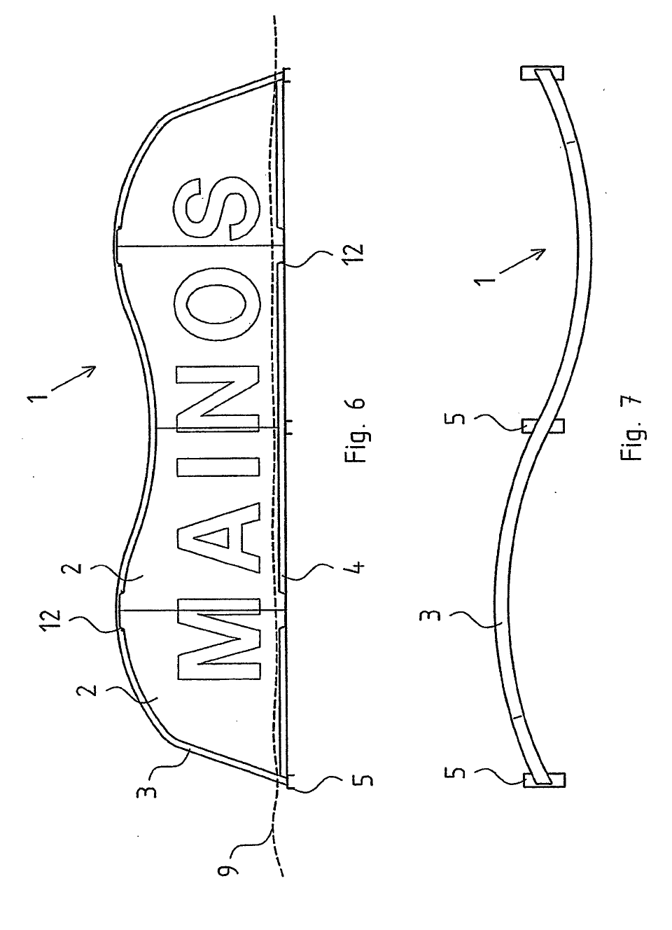

FIG. 7 shows one form of alternative advertising stand from above.

Advertising stand 1 as per the invention is formed of a steel framework and of advertising surfaces 2 fixed on both sides. Advertising stand 1 is made into form of a bent upper profile 3 of steel beginning from the under side of snow cover 9 and ending as a rack functioning as a place of performance, into which lower profile 4 and supports 5 that remain under snow cover are fixed, for instance by welding, and also back nets 6 and supporting structures 7 (FIG. 3) support the advertising space. Upper and lower profiles 3 and 4 form together with back nets 6 on both sides of the advertising stand grooves 13, into which light-construction advertising surfaces 2 are easily thread for fastening through openings 12 in the framework, leaving back nets 6 and other supporting structures 7 protected against down hill skiers. The support from supports 5 can be increased in joining additional supports 8 of wood or plastic to them (FIG. 4).

The most advantageous embodiments of the invention are presented in the above. However, the invention is not restricted to them only, but can vary in different ways within the limits of the claims. An advertising stand as per the invention can, if necessary be formed combining many framework modules of a different shape. The advertising stand framework can also be made as a lighter construction and one can use one or more advertising surfaces as supporting structure of the stand. Upper profile 3 can also be formed of several parts, for instance of pipe profile 10 or flat profile 11, so that it with back net 6, which supports the advertising surface, forms a groove 13 for fixing the advertising surface (FIG. 5). The shape and size can also vary remarkably according to the needs of the place of performance (FIGS. 6 and 7). As manufacturing material of the advertising stand can also other material than steel, for instance wood, plastic or similar, or combinations of them all be used. The suspension between the upper and lower framework parts can instead of vertical supports 7 be made by means of sheet structure. Most suitably the sheet fills the whole space between the upper and lower framework parts. The sheet then works as the one (inner) side surface of groove 13 on both sides of the stand. The sheet structure can be plywood, metal sheet or coated foam plastic, as foam plastic covered with reinforced plastic. No back net is needed, if a there is a sheet as supporting structure.

1. An advertising stand to be used in a winter sport resort, comprised of frame portion and of a foot portion placed under the snow cover and a frame portion placed above the snow cover, characterized in that upper and lower portions are profiles and between them one or more advertising surfaces can be fixed and that frame profile above the snow cover is arranged as a performance place of the winter sport resort, as a rail, on which it is possible to move, for instance with a snow board.

2. An advertising stand according to claim 1 characterized in that that the framework of the advertising stand is formed of an upper profile, bent of steel, beginning and ending from the under side of snow cover and of one or several supports.

3. An advertising stand according to claim 1 characterized in that in the advertising stand one or more advertising surfaces are fixed to protect the supporting structures of advertising stand.

4. An advertising stand according to claim 1 characterized in that with upper profile, lower profile and one or several back nets a groove is formed for fixing one or several advertising surfaces by threading.

5. An advertising stand according to claim 1 characterized in that one or several additional supports of softer material than the framework can be fixed in the framework of advertising stand.

6. An advertising stand according to claim 1 characterized in that between upper and lower profile a sheet is fitted working as supporting structure of said profiles and forming one side of groove.

7. An advertising stand according to claim 1 characterized in that the sheet is plywood, metal, covered sheet of foam plastic. etc.
